(19) United States
(12) Patent Application Publication
(10) Pub. No.: US 2025/0072651 A1
(43) Pub. Date: Mar. 6, 2025

(54) TELESCOPING NEEDLE STRUCTURE AND COFFEE MACHINE

(71) Applicant: Xiaojun Wang, Foshan (CN)

(72) Inventor: Xiaojun Wang, Foshan (CN)

(21) Appl. No.: 18/657,666

(22) Filed: May 7, 2024

(30) Foreign Application Priority Data
Sep. 4, 2023 (CN) 202322400050.6

(51) Int. Cl. A47J 31/40

(52) U.S. Cl. CPC A47J 31/407

(57) ABSTRACT

The present invention discloses a telescoping needle structure and a coffee machine, including a handle, a top lid and a lower lid, a needle, structure includes a sliding seat sleeving a plurality of guiding posts of the lower lid, a needle is installed on the sliding seat, a lower portion of the handle is provided with a crank, in which a guiding groove is arranged, a first rotating shaft is rotatably connected with the sliding seat in the guiding groove, the first rotating shaft moves in the guiding groove to drive the sliding seat to enable the needle to stretch out and draw back. In the present invention, the first rotating shaft sliding in the guiding groove of the handle drives the sliding seat to slide up and down and enables the needle to reliably stretch out and draw back.

### CROSS-REFERENCE TO RELATED APPLICATIONS

This application claims priority of Chinese Patent Application No. 202322400050.6, filed on Sep. 4, 2023, the entire contents of which are incorporated herein by reference.

### FIELD OF THE INVENTION

The present invention relates to the technical field of beverage extraction machines, specifically to a telescoping needle structure and a coffee machine.

### BACKGROUND OF THE INVENTION

Among current coffee machines, a capsule coffee machine is widely used as it is easily used and provides variety of flavors. However, the machine needs to puncture a coffee capsule by means of a needle and then pours water to brew coffee, and the needle is generally arranged in a upper lid of the coffee machine, so a user opens and closes the upper lid, usually causing the needle to be exposed, resulting in pricking the user.

CN201820049784.0 discloses a telescoping needle mechanism for a capsule coffee machine. In this technical solution, a linkage mechanism is used to drive a telescoping needle, but this technical solution has deficiencies of poorness in reliability and lack of an interlocking action that follows with actions of opening and closing a upper cover, causing a retracted needle not to be locked after the upper cover is opened, as well as poorness in convenience and insufficiency in safety.

### SUMMARY OF THE INVENTION

The objective of the present invention is to provide a telescoping needle structure and a coffee machine, so as to solve the problem of poorness in reliability and lack of an interlocking action that follows with actions of opening and closing a upper cover, causing a retracted needle not to be locked after the upper cover is opened, as well as poorness in convenience and insufficiency in safety and overcome the deficiencies as those in the prior art.

The present invention provides a telescoping needle structure, including a handle, a top lid and a lower lid, wherein the lower lid is arranged on the upper portion of a machine body and is hinged with the machine body, a needle means is arranged inside an accommodating chamber formed by closing the top lid and the lower lid together, the handle is hinged on the lower lid and rotates between a first position and a second position with respect to the top lid, the needle means includes a sliding seat sleeving a plurality of guiding posts of the lower lid, a needle is installed on the sliding seat, a lower portion of the handle is provided with a crank, in which a guiding groove is arranged, a first rotating shaft is rotatably connected with the sliding seat in the guiding groove, the first rotating shaft moves in the guiding groove to drive the sliding seat to enable the needle to stretch out and draw back.

The present invention also provides a coffee machine, including a machine body and the above-mentioned telescoping needle structure.

We have described other characteristic advantages and examples of the present invention in the claims of the present application, which complete the present description.

In a preferred example, the coffee machine includes a fixing seat, which is arranged inside the lower lid in the telescoping needle structure, the handle is hinged with the fixing seat by means of a second shaft sleeve, of which the end is provided with a pin through hole, inside which a pin is arranged, a vertical position-restricting through hole that penetrates the lower lid is arranged inside the fixing seat, a position-restricting post is arranged inside the position-restricting through hole; when the handle rotates to the second position, the pin rotates to the right above of the position-restricting through hole, one end of the pin extends into the position-restricting through hole, and the pin pushes the position-restricting post to exert a force to the machine body.

### BRIEF DESCRIPTION OF THE DRAWINGS

Referring to a set of drawings that exemplify non-restrictive embodiments of the present invention, the present invention will be better understood and more specifically presented by way of reading the description.

FIG. 1 shows a state of opening the lids while using a telescoping needle structure and a coffee machine in the present invention.

FIG. 2 is an exploded view of the telescoping needle structure of the present invention.

FIG. 3 shows a state of closing the lids while using the coffee machine in the present invention.

FIG. 4 is an overall schematic diagram of the handle and the pin at the first position.

FIG. 5 is an overall schematic diagram of the handle and the crank at the first position.

FIG. 6 is an overall schematic diagram of the needle and the sliding seat at the first position.

FIG. 7 is an overall schematic diagram of the third rotating shaft and the torsional spring at the first position.

FIG. 8 is an overall schematic diagram of the handle and the pin at the second position.

FIG. 9 is an overall schematic diagram of the handle and the crank at the second position.

FIG. 10 is an enlarged view at C in FIG. 8.

FIG. 11 is an enlarged view at D in FIG. 9.

FIG. 12 is an enlarged view at E in FIG. 4.

FIG. 13 is an enlarged view at F in FIG. 5.

FIG. 14 is a sectional diagram of the coffee machine having the handle with a suction means.

FIG. 15 is a sectional diagram showing operation of the pin.

### DETAILED DESCRIPTION OF SOME EMBODIMENTS

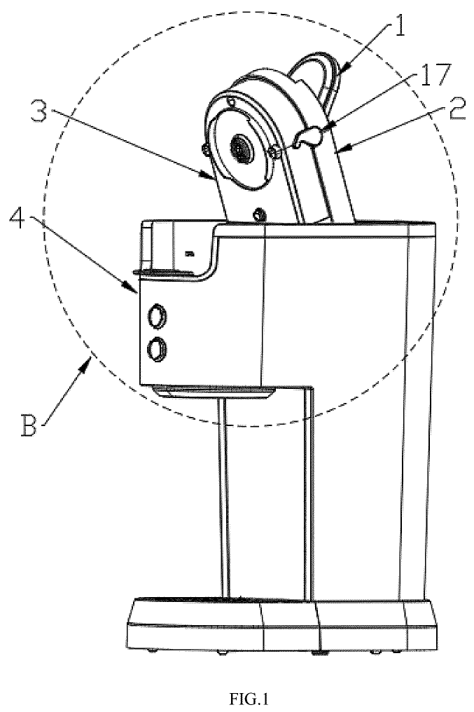

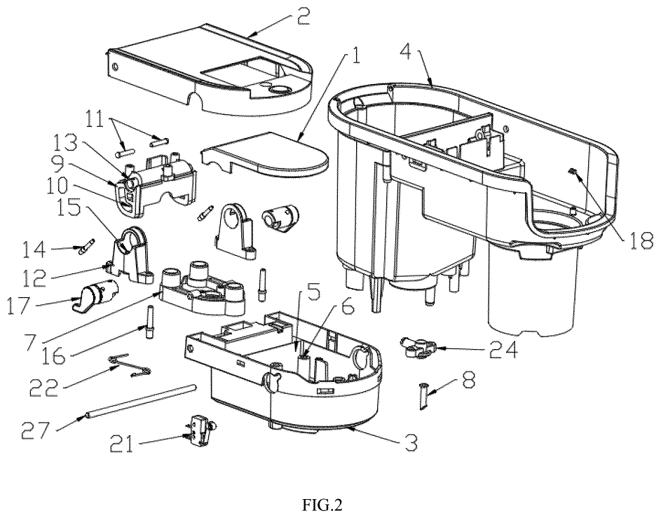

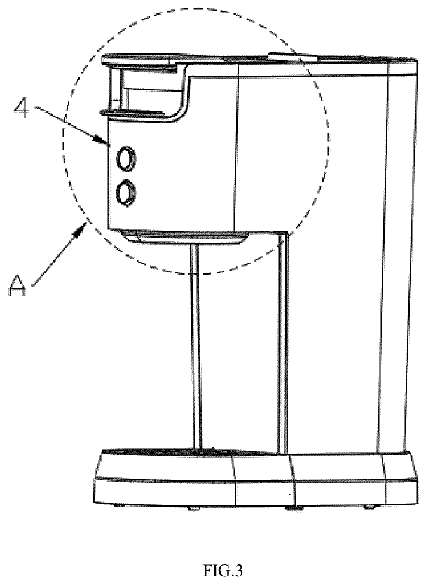

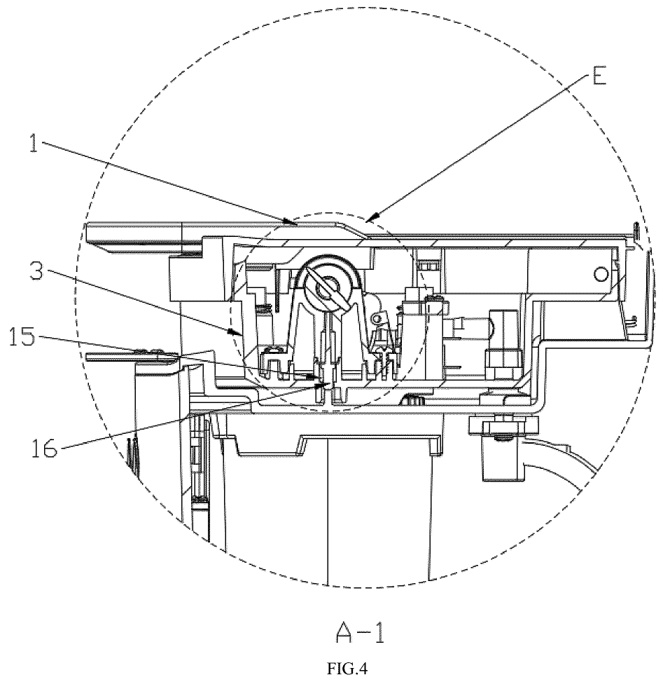

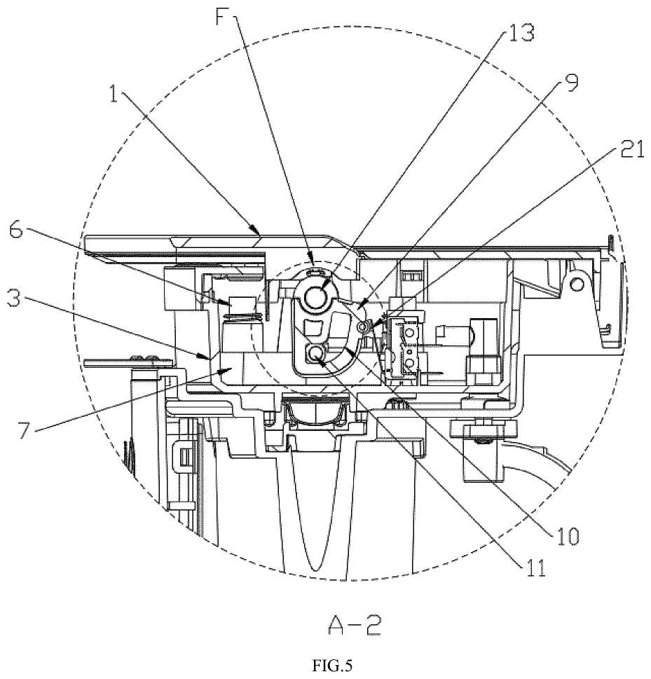

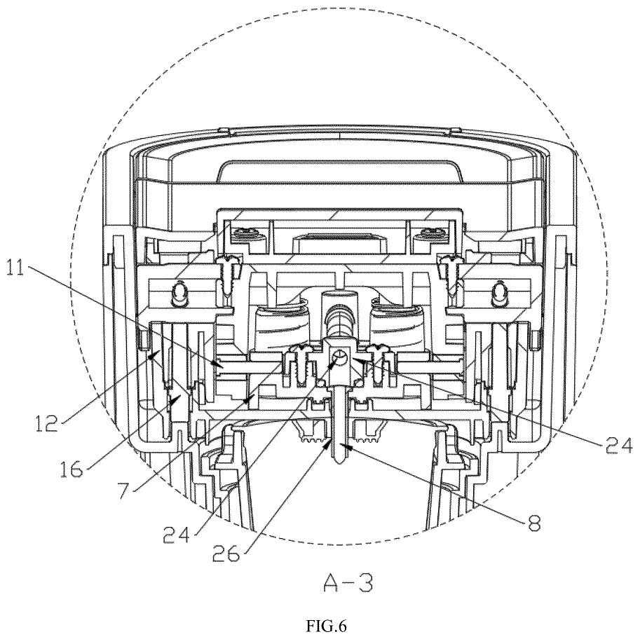

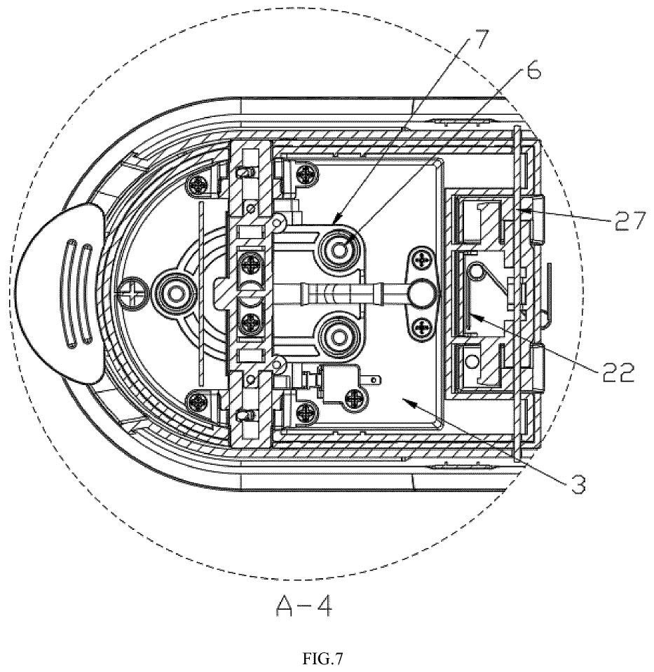

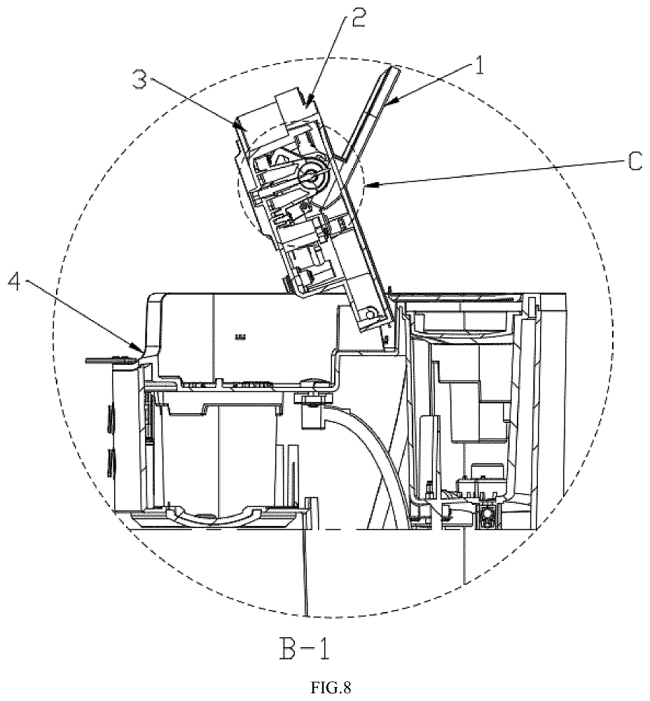

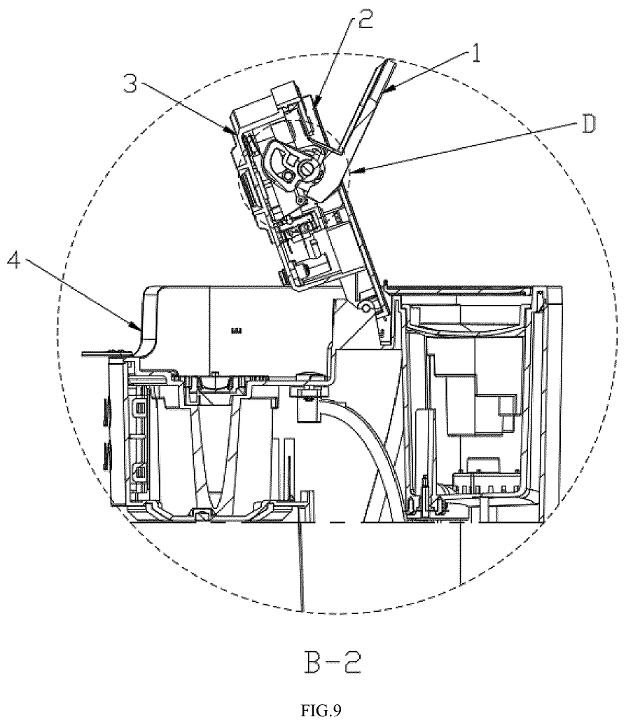

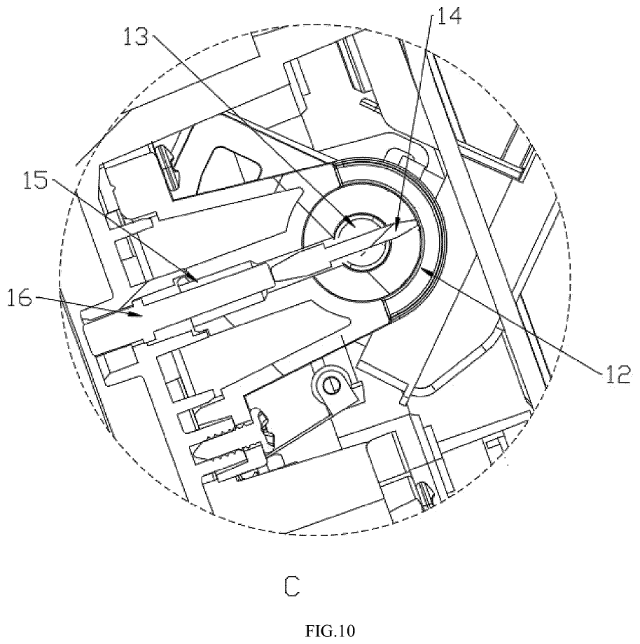

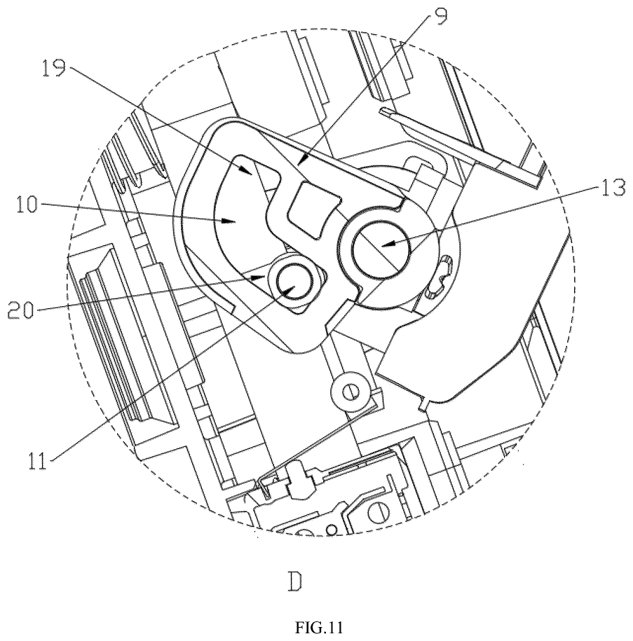

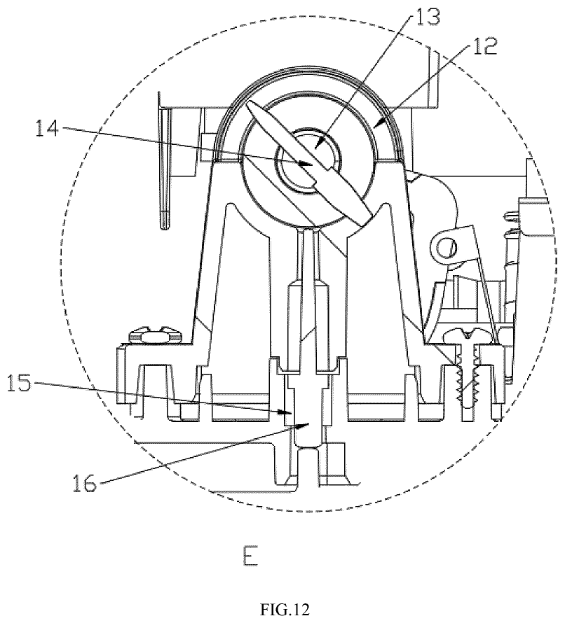

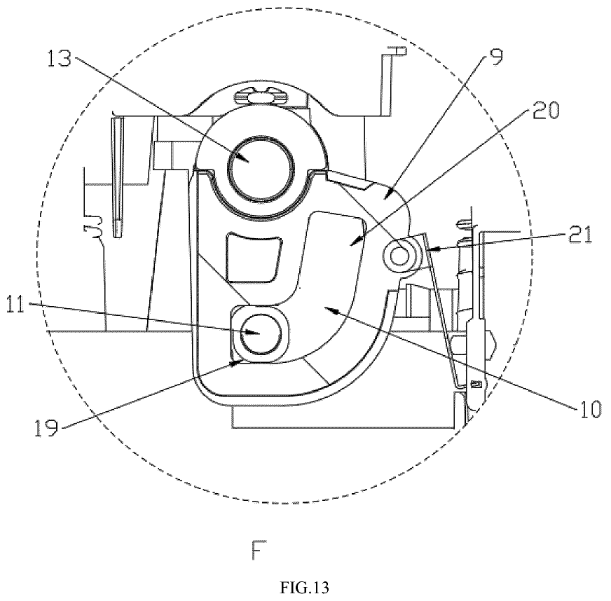

As shown in FIGS. 1-13, a telescoping needle structure includes a handle a, a top lid 2 and a lower lid 3, wherein the lower lid 3 is arranged on the upper portion of a machine body 4 and is hinged with the machine body 4, a needle means is arranged inside an accommodating chamber 5 formed by closing the top lid 2 and the lower lid 3 together, the handle 1 is hinged on the lower lid 3 and rotates between a first position (referring to FIGS. 3-5) and a second position (referring to 1, 8 and 9) with respect to the top lid 2, the needle means includes a sliding seat 7 sleeving a plurality of guiding posts 6 of said lower lid 3, a needle 8 is installed on the sliding seat 7, a lower portion of the handle 7 is provided with a crank 9, in which a guiding groove 10 is arranged, a first rotating shaft 11 is rotatably connected with the sliding seat 7 in the guiding groove 10, the first rotating shaft 11 moves in the guiding groove 10 to drive the sliding seat 7 to enable the needle 8 to stretch out and draw back.

The handle is connected with the sliding seat where the needle is installed through the first rotating shaft, and the first rotating shaft sliding in the guiding groove of the handle drives the sliding seat to slide up and down and enables the needle to reliably stretch out and draw back.

In this example, the needle 8 is enabled to stretch out and draw back while interacting with the action of opening and closing the lids, and the needle 8 is enabled to stretch out and draw back by rotating the handle 1 between the first position and the second position, so that the rotation of the handle 1 between the first position and the second position interacts with the action of opening and closing the lids.

The crank 9 is arranged on both sides of a handle seat, which is fixed with the handle, the second shaft sleeve 13 is installed on the left and right sides of the handle seat or integrated with the handle seat, the second shaft sleeve 13 passes through the sleeve piece of the fixing seat 12, the fixing seat is used as a hinge seat that makes the handle and the handle seat rotate around the central axis of the sleeve piece.

The movable position-restricting post 16 is arranged inside the position-restricting through hole, the pin that enters the position-restricting through hole will push the position-restricting post to make the bottom of the position-restricting post stretch out from the below of the position-restricting through hole under the action of a spring, and stand against the protruding post of the machine body, thereby levering up the lower lid. At this time, the handle is continuously pulled in the direction of opening the handle, so as to open the lower lid, and the lower lid will rotate around the third rotating shaft 27, so as to open an opening of a capsule brewing chamber of the machine body 4, through which capsules can be replaced. The action of closing the lids makes the lower lid rotate in the direction of closing the opening of the capsule brewing chamber; when the bottom of the position-restricting post is under the force of propping the machine body, the position-restricting post overcomes a spring force to push the pin out of the position-restricting through hole, thereby relieving the restriction to the rotating handle from the pin, thus the handle rotates from the second position to the first position.

When it is necessary to open the lids.

It is default that the handle 1 stands at the first position (see a state of closing the lids as shown in FIG. 3), the handle 1 is pulled to drive the second shaft sleeve 13 to rotate, the end of the second shaft sleeve 13 is provided with a swing hook 17; the action of closing the lids makes the swing hook 17 hook a block 18 arranged on the inner side wall of the machine body 4; when the second shaft sleeve 13 rotates, it drives the swing hook 17 to separate from the block 18; at the same time, the handle 1 drives the crank 9 arranged on both sides of the lower portion of the handle 1 to rotate, the guiding groove 10 is arranged inside the crank 9, the guiding groove 10 includes a first section 19 and a second section 20, which intersect with each other to form an angle, and both of the sections have an arc-shaped transition connection portion. When the handle 1 stands at the first position, the first rotating shaft 11 stands at the first section 19; the crank 9 rotates to drive the first rotating shaft to move from the first section 19 to the second section 20. When the handle 1 stands at the second position, the first rotating shaft 11 slides from the first section 19 to the second section 20; in addition, the fixing seat 12 is arranged inside the lower lid 3, the handle 1 is hinged with the fixing seat 12 through the second shaft sleeve 13, the pin 14 radially penetrates the second shaft sleeve 13 with respect to the protruding end of the fixing seat 12, and the second shaft sleeve 13 rotates to drive the pin 14 to rotate vertically.

When the handle 1 rotates to the second position, the swing hook 17 separates from the block 18 arranged on the adjacent machine body 4; the first rotating shaft 11 moves from the first section 19 to the second section 20, thereby driving the sliding seat 7 to rise from the lower lid 3, and the center of the sliding seat 7 is provided with a needle seat 24, in which a horizontal inner hole 25 and a vertical inner hole 26 communicating with each other are arranged, the horizontal inner hole 24 communicates with a water-feeding passage of the machine body 4; the needle 8 is arranged at the end of the vertical inner hole 26 and passes through the lower lid 3 downwards, extending into the machine body 4, so that the raised sliding seat 7 also drives the needle 8 to retract into the bottom surface of the lower lid 3; a vertical position-restricting through hole 15 that penetrates the lower lid 3 is arranged inside the fixing seat 12, when the handle 1 rotates to the second position, it drives the pin 14 to rotate to a vertical direction right above the position-restricting through hole 15, thus the pin 14 falls into the position-restricting through hole 15, thereby restricting the handle 1 from continuing to rotate, so that the handle 1 remains at the second position.

Because the movable position-restricting post 16 is arranged inside the position-restricting through hole 15, after the pin 14 falls into the position-restricting through hole 15, it pushes the top of the position-restricting post 16 to enable the bottom of the position-restricting post 16 to stretch out from the below of the lower lid 3, so as to stand against the machine body 4 and lever up the lower lid 3; the swing hook 17 separates from the block 18 arranged on the adjacent machine body 4, releasing the restriction to the rotation of the lower lid 3; the handle 1 is continuously pulled to drive the lower lid 3 to turn over and enable the lid to open.

The pin that is installed in the second shaft sleeve connected to the handle and the lower lid can limit the rotation of the handle, so as to keep the needle retracted, achieving an interaction effect of opening and closing the lids, and the needle remains retracted after the lid is opened, improving convenience and safety of use.

When it is necessary to close the lids.

The handle 1 is pressed down, and the handle 1 drives the lower lid 3 to turn over and close the lids.

The bottom of the position-restricting post 16 exposed on the bottom surface of the lower lid 3 is pushed up by the machine body 4, so as to drive the top of the position-restricting post 16 to push the pin 14 out of the position-restricting through hole 15, releasing the restriction to the rotation of the handle 1.

The handle 1 is continuously pressed to rotate from the second position to the first position, and the crank 9 rotates and drives the first rotating shaft to move from the second section 20 to the first section 19, and the sliding seat 7 descends again; when the handle 1 is turned to the first position, the needle 7 stretches into the machine body 4 again, and the swing hook 17 hooks the block 18, restricting the lower lid 3 from further rotation, so far, completing closing the lids.

When the handle 1 lies at the first position, the needle 8 stretches out normally; when the handle 1 lies at the second position, the needle 8 retracts into the bottom surface of the lower lid 3 and gets hidden. Only after the handle 1 rotates to the second position, the lid can be opened; thus, the needle 8 always keeps retracted after the lid has been opened, avoiding an accidental puncture arising from exposure. Only after the lid is closed, the handle 1 rotates from the second position to the first position and makes the needle stretch out. Therefore, in the whole process of opening and closing the lids, the needle 8 reliably stretches out and draws back, meanwhile also interacts with the action of opening and closing lids, realizing high convenience and safety.

In this example, a rotatable shaft sleeve can also be arranged on the first rotating shaft 11.

Further, the lower lid 3 is further provided with a micro switch 21 matched with the crank 11, and the micro switch 21 controls starting of programs for operation such as feeding water into the coffee machine and heating water; only when the handle 1 lies at the first position, the crank 11 touching and pressing the micro switch 21 can start the procedures such as feeding and heating water, thereby avoiding mis-starting during opening the lids or not closing the lids normally and further improving safety.

The lower lid 3 is hinged with the machine body 4 through the third rotating shaft 27, and a torsional spring 22 is further arranged between the lower lid 3 and the machine body 4. When it is necessary to open the lids, turning over the lower lid 3 needs to overcome the torsion force of the torsional spring 22; after the lower lid 3 has turned over to a certain angle, the torque of the torsional spring 22 is released and continues to assist the lower lid 3 to turn over to a maximum opening position; on the contrary, closing the lids also needs to overcome a certain torque in advance, and then complete the action of closing the lids more easily under assistance of the torsional spring 22. Thus, the torsional spring 22 is configured to achieve a more reasonable pressure effect in the process of opening and closing the lids.

Further, an elastic element can be arranged on the guiding post 6, so as to enable the sliding seat 7 to have better reliability when it ascends and descends.

The present invention also provides a coffee machine, which includes a body that is used to achieve functions such as feeding water and heating water and the telescoping needle structure according to the present invention.

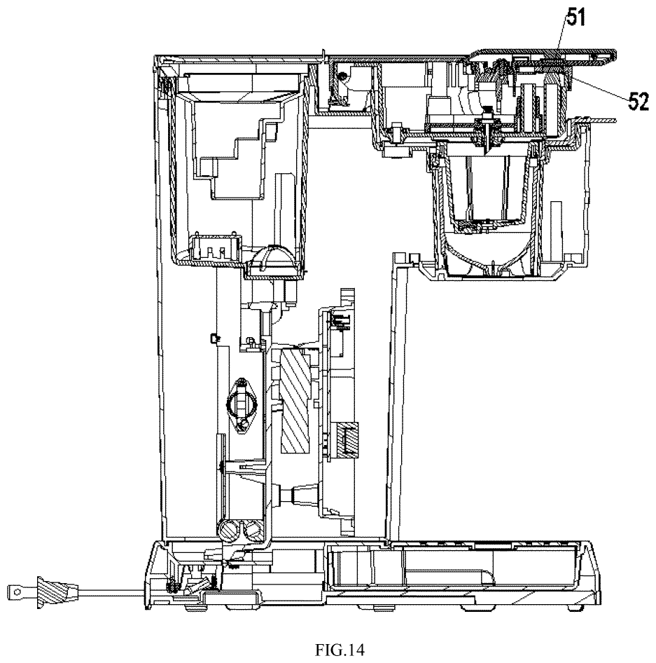

Referring to FIG. 14, as another embodiment, in order to prevent the handle from unexpectedly moving from the lid-closing state to the second position, for example, lifting upwards unintentionally under vibration, a suction means is arranged between the handle and the upper lid 2. When it is necessary to open the handle of the coffee maker, the handle firstly overcomes the suction force of the suction means and then rotates from the first position to the second position. Specifically, the suction means may be a pair of magnets (51, 52) that attract each other, one is arranged in the handle 1 and the other is arranged at the front end of the top lid 2 and is positioned right below the magnet of the handle.

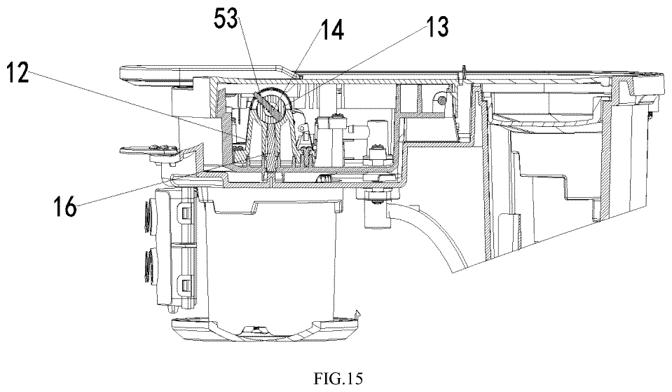

Referring to FIG. 15, the fixing seat 12 is arranged in the lower lid, and handle 1 is hinged with the fixing seat through the second shaft sleeve 13, of which the end is provided with a pin through hole, in which the pin is arranged; the pin is movable in the through hole in the radial direction and has a spring step, and of a pin spring 53 one end presses on the spring step, and the other end presses against the inner wall of the second shaft sleeve; the vertically-upward position-restricting through hole that penetrates the lower lid is arranged inside the fixing seat, and the position-restricting post is arranged in the position-restricting through hole. When the handle rotates to the second position, the first rotating shaft 11 stands at a stroke stop position of the second section 20, the pin through hole is directly opposite the position-restricting through hole, and the elastic force of the pin spring 53 pushes the pin 14 to press to the position-restricting post 16 in the position-restricting through hole, so that the position-restricting post 16 exerts a force to the protrusion of the bottom surface of the machine body 4. When the lower lid 3 lifts up and leaves the machine body along with the handle, the pin 14 stretches into the position-restricting through hole, so that the handle maintains at the second position in the subsequent stroke. The lower end of the position-restricting post 16 is provided with a protruding position-restricting ring, which is used to prevent the position-restricting post 16 from falling from the position-restricting through hole in the process of opening the lids.

It should be understood that the drawings merely illustrate examples given only as practical examples of the present invention and which may change in form and arrangement without deviating from the conceptual scope on which the present invention is based. Drawing marks are optionally made in the claims, so as to facilitate reading the claims with reference to the description and drawings, but they do not pose any limitation on the protection scope claimed as the claims.

1. A telescoping needle structure, comprising:
a top lid and a lower lid, which are arranged on a upper portion of a machine body and hinged with said machine body,
a needle means arranged inside an accommodating chamber formed by closing said top lid and said lower lid together, and
a handle hinged on said lower lid and rotates between a first position and a second position with respect to said top lid,
wherein said needle means comprises a sliding seat sleeving a plurality of guiding posts of said lower lid, a needle is installed on said sliding seat, a lower portion of said handle is provided with a crank, in which a guiding groove is arranged, a first rotating shaft is rotatably connected with said sliding seat in said guiding groove, said first rotating shaft moves in said guiding groove to drive said sliding seat to move up and down, so as to enable said needle to stretch out and draw back.

2. The telescoping needle structure according to claim 1, wherein a fixing seat is arranged inside said lower lid, said handle is hinged with said fixing seat by means of a second shaft sleeve, of which the end is provided with a pin through hole, inside which a pin is arranged, a vertical position-restricting through hole that penetrates said lower lid is arranged inside said fixing seat, a position-restricting post is arranged inside said position-restricting through hole; when said handle rotates to said second position, said pin rotates to the right above of said position-restricting through hole, one end of said pin extends into said position-restricting through hole, and said pin pushes said position-restricting post to exert a force to said machine body.

3. The telescoping needle structure according to claim 2, wherein an end of said second shaft sleeve is also provided with a swing hook, which fits with a block arranged on the adjacent machine body; when said handle lies at said first position, said swing hook hooks said block and restricts said lower lid from rotation, when the handle lies at said second position, said swing hook separates from said block, so as to release the restriction to the rotation of said lower lid.

4. The telescoping needle structure according to claim 1, wherein said crank is arranged on both sides of a lower portion of said handle, said guiding groove comprises a first section and a second section, said first rotating shaft stands at said first section when said handle lies at said first position, said first rotating shaft slides from said first section to said second section when said handle lies at said second position.

5. The telescoping needle structure according to claim 1, wherein said lower lid is further provided with a micro switch matched with said crank, when said handle lies at said first position, said crank touches and presses said micro switch.

6. The telescoping needle structure according to claim 3, wherein said lower lid is hinged with said machine body through a third rotating shaft, and a torsional spring is further arranged between said lower lid and said machine body.

7. The telescoping needle structure according to claim 1, wherein the center of said sliding seat is provided with a needle seat, in which a horizontal inner hole and a vertical inner hole communicating with each other are arranged, said horizontal inner hole communicates with a water-feeding passage of said machine body, said needle is arranged at an end of said vertical inner hole.

8. The telescoping needle structure according to claim 1, wherein a suction means is arranged between said handle and said upper lid.

9. The telescoping needle structure according to claim 8, wherein said suction means is a pair of magnets, of which one is arranged inside said handle and the other is arranged on said top lid.

10. A coffee machine, comprising a machine body and the telescoping needle structure according to claim 1.
